(19) United States
(12) Patent Application Publication
(10) Pub. No.: US 2014/0181509 A1
(43) Pub. Date: Jun. 26, 2014

(54) METHOD AND APPARATUS FOR VERIFYING ANTI-COUNTERFEITING INFORMATION

(71) Applicants: Founder Mobile Media Technology(Beijing) Co., Ltd., Beijing (CN); PEKING UNIVERSITY FOUNDER GROUP CO., LTD., Beijing (CN)

(72) Inventor: Tao LIU, Beijing (CN)

(73) Assignees: Founder Mobile Media Technology(Beijing) Co., Ltd., Beijing (CN); PEKING UNIVERSITY FOUNDER GROUP CO., LTD., Beijing (CN)

(21) Appl. No.: 14/092,750

(22) Filed: Nov. 27, 2013

(30) Foreign Application Priority Data
Dec. 26, 2012 (CN) 201210575554.5

(51) Int. Cl. H04L 29/06

(52) U.S. Cl. CPC H04L 63/0428
USPC 713/162

(57) ABSTRACT

A method and apparatus for verifying anti-counterfeiting information are provided so as to improve an anti-counterfeiting effect, to lower an anti-counterfeiting cost, to extend the scope of population to which anti-counterfeiting effect is applicable and to guarantee the stability of anti-counterfeiting means. The method includes: a terminal obtains and parses encrypted address information of an object; the terminal connects to a network address corresponding to the parsed encrypted address information; the terminal determines that the encrypted address information is valid upon successful connection and sending verification information of the object to the network address corresponding to the encrypted address information; and the terminal receives feedback information about whether the verification information is valid.

### CROSS-REFERENCE TO RELATED APPLICATIONS

The present application claims priority to Chinese Patent Application No. 201210575554.5 filed with the Chinese Patent Office on Dec. 26, 2012 and entitled “method and apparatus for verifying anti-counterfeiting information”, which is hereby incorporated by reference in its entirety.

### FIELD OF THE INVENTION

The present invention relates to the field of anti-counterfeiting and particularly to a method and apparatus for verifying anti-counterfeiting information.

### BACKGROUND OF THE INVENTION

How to improve anti-counterfeiting technologies of products has become an issue highly desirable by producers and sellers to be addressed along with constant emergence of fake and inferior commodities and constantly upgraded means of producing and selling fake products. Existing anti-counterfeiting technologies common in the market include pattern anti-counterfeiting, wetness-sensitive anti-counterfeiting, watermark anti-counterfeiting, a Radio Frequency Identification (RFID) chip, etc., all of which have their numerous technical drawbacks and problems including an insignificant anti-counterfeiting effect and a low counterfeiting threshold; instable anti-counterfeiting; and non-adaptiveness to different customers. Consequently the existing anti-counterfeiting technologies are desirable to be further improved and enhanced.

### SUMMARY OF THE INVENTION

Embodiments of the invention provide a method and apparatus for verifying anti-counterfeiting information so as to improve an anti-counterfeiting effect, to extend the scope of population to which anti-counterfeiting effect is applicable and to guarantee the stability of anti-counterfeiting means.

An embodiment of the invention provides a method for verifying anti-counterfeiting information, the method including:

obtaining and parsing, by a terminal, encrypted address information of an object;

connecting, by the terminal, to a network address corresponding to the parsed encrypted address information;

determining, by the terminal, that the encrypted address information is valid upon successful connection and sending verification information of the object to the network address corresponding to the encrypted address information; and

receiving, by the terminal, feedback information about whether the verification information is valid.

An embodiment of the invention provides another method for verifying anti-counterfeiting information, the method including:

receiving a request from a terminal for connection to a specific network address;

setting up a connection of the terminal to the specific network address upon determining that the specific network address or encrypted address information corresponding to the specific network address is valid;

receiving verification information sent from the terminal to the specific network address; and

sending feedback information about whether the verification information is valid to the terminal.

An embodiment of the invention provides an apparatus for verifying anti-counterfeiting information, the apparatus including:

an encrypted address information processing unit configured to obtain and parse encrypted address information of an object;

a network connecting unit configured to connect to a network address corresponding to the parsed encrypted address information;

a verification information sending unit configured to determine that the encrypted address information is valid upon successful connection and send verification information of the object to the network address corresponding to the encrypted address information; and

a feedback receiving unit configured to receive feedback information about whether the verification information is valid.

An embodiment of the invention provides another apparatus for verifying anti-counterfeiting information, the apparatus including:

a network connection receiving unit configured to receive a request from a terminal for connection to a specific network address;

a network connection processing unit configured to set up a connection of the terminal to the specific network address upon determining that the specific network address or encrypted address information corresponding to the specific network address is valid;

a verification information receiving unit configured to receive verification information sent from the terminal to the specific network address; and

a feedback sending unit configured to send feedback information about whether the verification information is valid to the terminal.

As can be apparent from the foregoing technical solutions, in the invention, a terminal obtains and parses encrypted address information of an object; the terminal connects to a network address corresponding to the parsed encrypted address information; the terminal determines that the encrypted address information is valid upon successful connection and sends verification information of the object to the network address corresponding to the encrypted address information; and the terminal receives feedback information about whether the verification information is valid. With the invention, the encrypted address information and the verification information are designed on the object so that the terminal parses the encrypted address information and connects to the network address for verification, and there is a strict correspondence relationship between the respective anti-counterfeiting elements, that is, different encrypted address information can only be parsed for a network address corresponding thereto, and each different network address can only have verification information corresponding thereto verified there, thereby improving an anti-counterfeiting effect; and also the terminal is easy for the user to obtain without any additionally purchased device, thus extending the scope of population to which anti-counterfeiting is applicable; and moreover the method can be embodied at the user side in the form of a client which is updated primarily in software, thereby also ensuring the stability of the technical.

### BRIEF DESCRIPTION OF THE DRAWINGS

FIG. 1 is a schematic flow chart of a method for verifying anti-counterfeiting information according to an embodiment of the invention;

FIG. 2 is a schematic flow chart of another method for verifying anti-counterfeiting information according to an embodiment of the invention;

FIG. 3 is a schematic flow chart of another method for verifying anti-counterfeiting information according to an embodiment of the invention;

FIG. 4 is a schematic flow chart of another method for verifying anti-counterfeiting information according to an embodiment of the invention;

FIG. 5 is a schematic flow chart of another method for verifying anti-counterfeiting information according to an embodiment of the invention;

FIG. 6 is a schematic flow chart of another method for verifying anti-counterfeiting information according to an embodiment of the invention;

FIG. 7 is a schematic flow chart of another method for verifying anti-counterfeiting information according to an embodiment of the invention;

FIG. 8 is a schematic flow chart of another method for verifying anti-counterfeiting information according to an embodiment of the invention;

FIG. 9 is a schematic flow chart of a method for verifying anti-counterfeiting information according to an embodiment of the invention;

FIG. 10 is a schematic diagram of a verification page according to an embodiment of the invention;

FIG. 11 is a schematic diagram of a superficial string of digits passing verification according to an embodiment of the invention;

FIG. 12 is a schematic diagram of an underlying string of digits passing verification according to an embodiment of the invention;

FIG. 13 is a schematic structural diagram of an apparatus for verifying anti-counterfeiting information according to an embodiment of the invention;

FIG. 14 is a schematic structural diagram of another apparatus for verifying anti-counterfeiting information according to an embodiment of the invention;

FIG. 15 is a schematic structural diagram of another apparatus for verifying anti-counterfeiting information according to an embodiment of the invention;

FIG. 16 is a schematic structural diagram of another apparatus for verifying anti-counterfeiting information according to an embodiment of the invention; and

FIG. 17 is a schematic structural diagram of another apparatus for verifying anti-counterfeiting information according to an embodiment of the invention.

### DETAILED DESCRIPTION OF THE EMBODIMENTS

Embodiments of the invention provide a method and apparatus for verifying anti-counterfeiting information so as to improve an anti-counterfeiting effect, to lower an anti-counterfeiting cost, to extend the scope of population to which anti-counterfeiting effect is applicable and to guarantee the stability of anti-counterfeiting means.

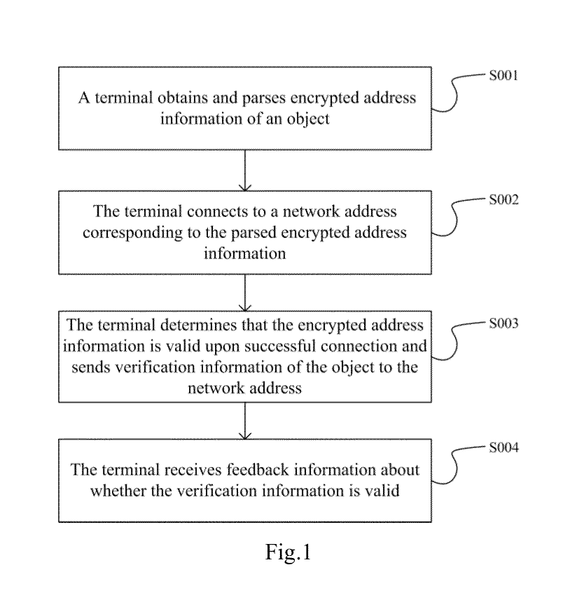

Referring to FIG. 1, a method for verifying anti-counterfeiting information according to an embodiment of the invention includes the following steps.

S001. A terminal obtains and parses encrypted address information of an object.

S002. The terminal connects to a network address corresponding to the parsed encrypted address information.

S003. The terminal determines that the encrypted address information is valid upon successful connection and sends verification information of the object to the network address corresponding to the encrypted address information.

S004. The terminal receives feedback information about whether the verification information is valid.

Preferably the encrypted address information is in the form of a two-dimension code, an RFID, Near Field Communication (NFC) or other technical forms; and all of technical forms which can include network address information and can be parsed will be employable with the invention.

Preferably the verification information is in the form of including but not limited to one or combination of digitals, letters, symbols, graphics, etc. Upon connection to the network address corresponding to the encrypted address information, the terminal sends to the address the verification information which can be obtained directly from the object. The sent verification information is the same as or has a preset correspondence relationship with contents as seen directly in the object about the verification information, for example, the verification information is indicated in the object as a123456, and then the sent verification information is also a123456; in another example, the verification information is indicated in the object as the sum of 3 and 5, and the sent verification information is the sum of 3 and 5, i.e., 8; and in still another example, the verification information of the object is an animal pattern, and the sent verification information is a Chinese animal name corresponding to the animal pattern.

Preferably the encrypted address information of the object parsed by the terminal can be correctly parsed only by the specified terminal according to the invention so as to ensure an anti-counterfeiting effect.

Preferably there are numerous schemes in which the encrypted address information is combined with the verification information, that is, the number of pieces of the encrypted address information and the verification information will not be limited. For example, first encrypted address information, second encrypted address information, third encrypted address information, first verification information, second verification information and third verification information can be combined in a scheme. Several preferred embodiments will be given below.

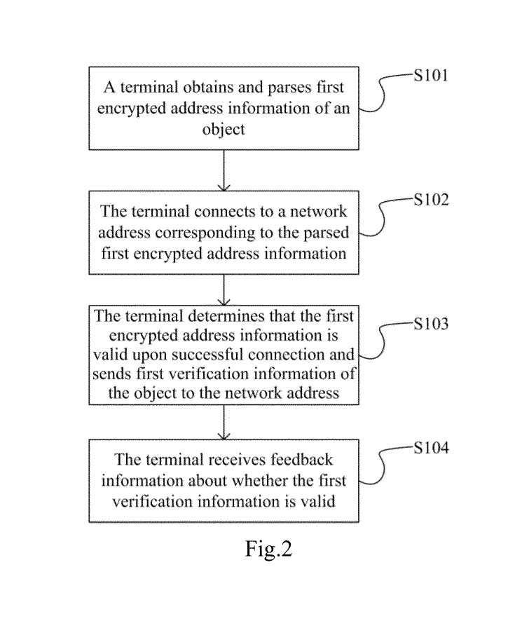

Preferably, referring to FIG. 2, the encrypted address information includes first encrypted address information, and the verification information includes first verification information, and the anti-counterfeiting verification includes the following steps.

S101. A terminal obtains and parses first encrypted address information of an object.

S102. The terminal connects to a network address corresponding to the parsed first encrypted address information.

S103. The terminal determines that the first encrypted address information is valid upon successful connection and sends first verification information of the object to the network address corresponding to the first encrypted address information.

S104. The terminal receives feedback information about whether the first verification information is valid.

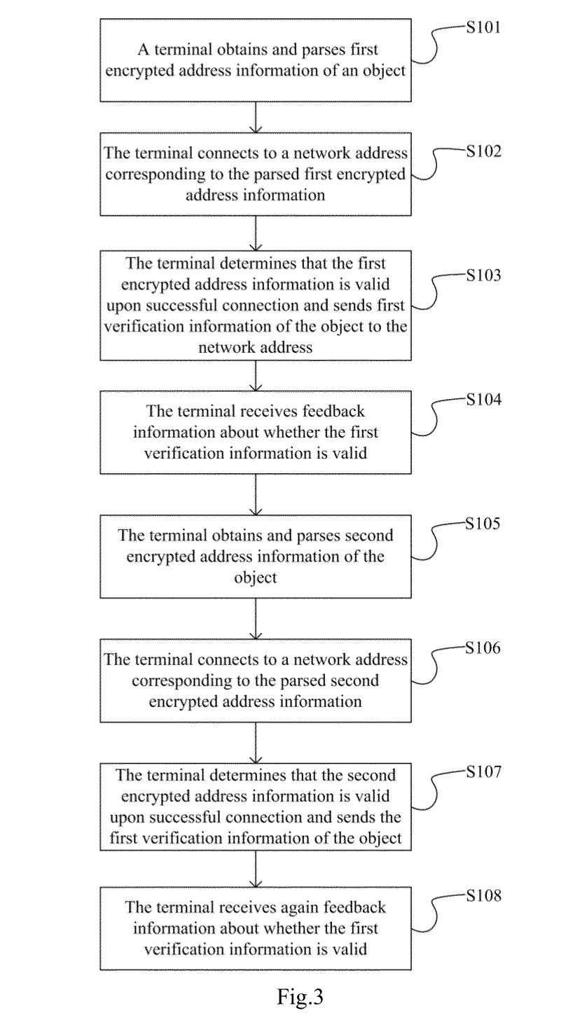

Preferably, referring to FIG. 3, when the object is provided with two levels of encrypted address information and one level of verification information, that is, when the encrypted address information of the object further includes second encrypted address information, the anti-counterfeiting verification following S101 to S104 further includes the following steps.

S105. The terminal obtains and parses second encrypted address information of the object.

S106. The terminal connects to a network address corresponding to the parsed second encrypted address information.

S107. The terminal determines that the second encrypted address information is valid upon successful connection and sends the first verification information of the object to the network address corresponding to the second encrypted address information.

S108. The terminal receives again feedback information about whether the first verification information is valid.

Preferably the second encrypted address information is difficult to obtain as compared with the first encrypted address information, for example, the second encrypted address information needs to be obtained by altering an original structure of the object.

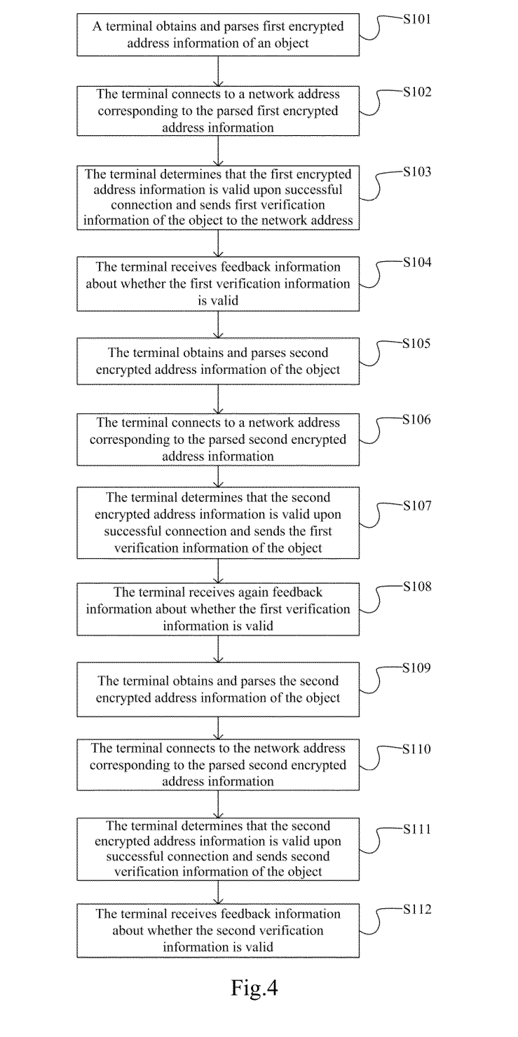

Preferably, referring to FIG. 4, when the object is provided with two levels of encrypted address information and two levels of verification information, that is, when the verification information of the object further includes second verification information, the anti-counterfeiting verification following S101 to S108 further includes the following steps.

S109. The terminal obtains and parses the second encrypted address information of the object.

S110. The terminal connects to the network address corresponding to the parsed second encrypted address information.

S111. The terminal determines that the second encrypted address information is valid upon successful connection and sends second verification information of the object to the network address corresponding to the second encrypted address information.

S112. The terminal receives feedback information about whether the second verification information is valid.

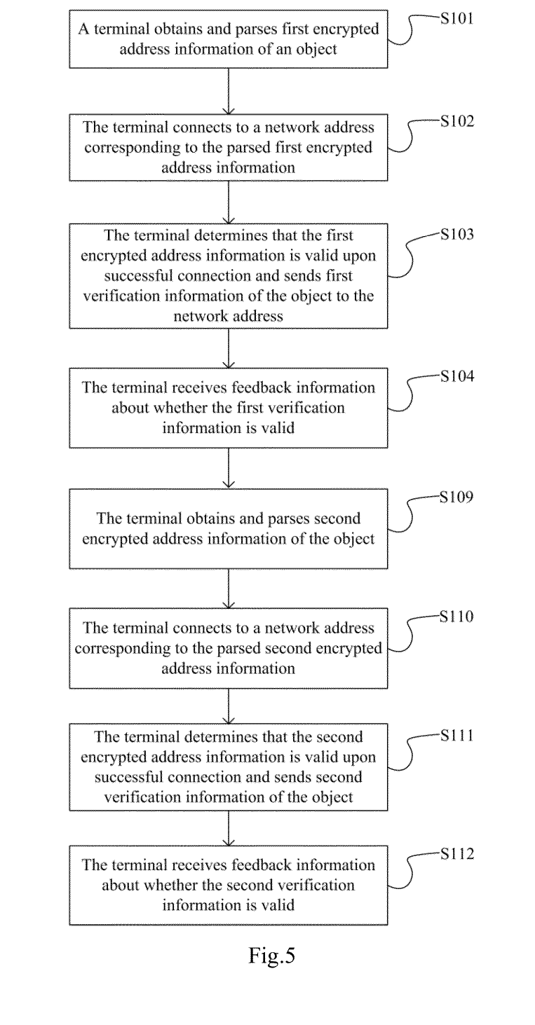

Preferably, referring to FIG. 5, when the object is provided with two levels of encrypted address information and two levels of verification information, the following steps also have the same verification effect: S101 to S104 and S109 and S112.

Preferably the second verification information is difficult to obtain as compared with the first verification information, for example, the second verification information needs to be obtained by altering an original structure of the object.

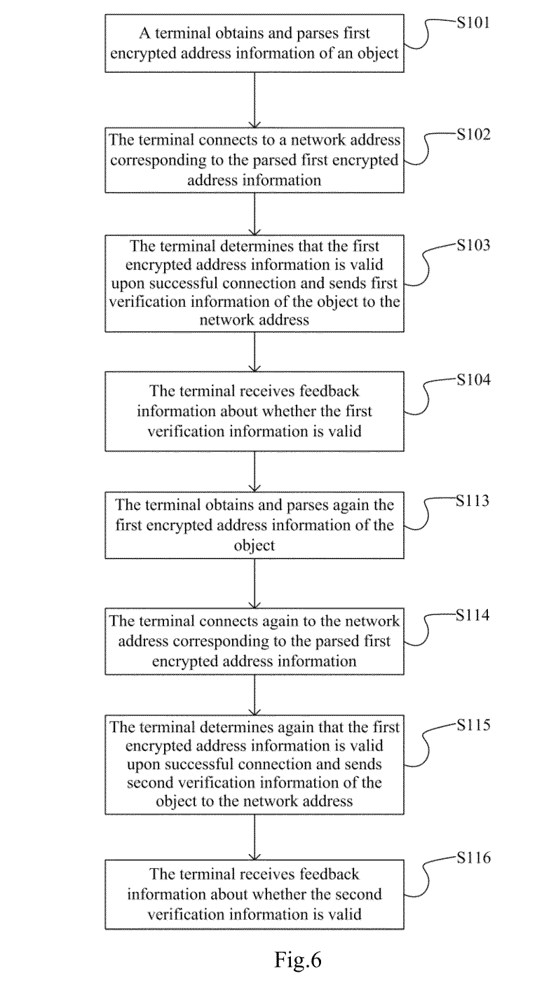

Preferably, referring to FIG. 6, when the object is provided with one level of encrypted address information and two levels of verification information, the verification following S101 to S104 further includes the following steps.

S113. The terminal obtains and parses again the first encrypted address information of the object.

S114. The terminal connects again to the network address corresponding to the parsed first encrypted address information.

S115. The terminal determines again that the first encrypted address information is valid upon successful connection and sends second verification information of the object to the network address corresponding to the first encrypted address information.

S116. The terminal receives feedback information about whether the second verification information is valid.

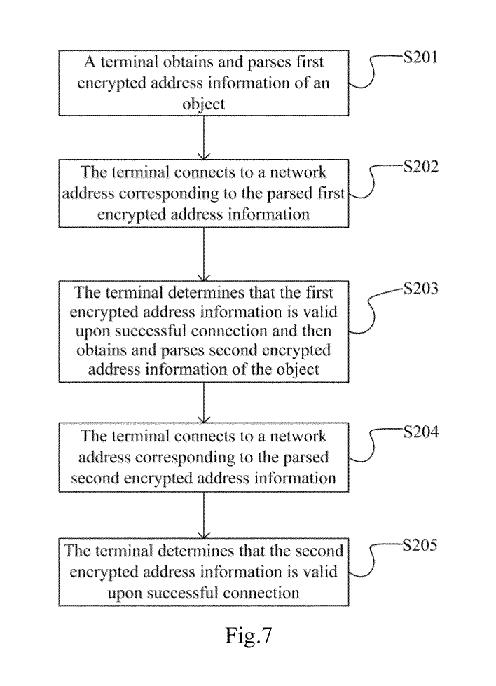

Preferably, referring to FIG. 7, there is also some counterfeiting effect when the object is provided only with two levels of encrypted address information.

S201. A terminal obtains and parses first encrypted address information of an object.

S202. The terminal connects to a network address corresponding to the parsed first encrypted address information.

S203. The terminal determines that the first encrypted address information is valid upon successful connection and then obtains and parses second encrypted address information of the object.

S204. The terminal connects to a network address corresponding to the parsed second encrypted address information.

S205. The terminal determines that the second encrypted address information is valid upon successful connection.

Preferably when the verification information is valid, the corresponding feedback information includes one or more of the following information: the name of the object corresponding to the verification information, the type of the verification information, a historical record of verification times of the verification information, an invalidation alert corresponding to the verification information, the remaining number of times that the verification information is to be verified, the accumulated number of times that the verification information has been verified, a domain where the terminal sending the verification information resides, and the model of the terminal sending the verification information. A user can inquire of a database of objects corresponding to the verification information, by the corresponding feedback information that the verification information is valid, to further determine whether the product is a fake. For example, the historical record of verification times of the verification information is compared with a historical record of verification times in the database of objects corresponding to the verification information to determine whether the product is a fake. The database of objects here refers to a database corresponding to a public network address specified by a producer of the object, for example a database in an official website, which guarantees accuracy and irreproducibility of anti-counterfeiting data, where the authenticity of the object is determined when the user determines that the feedback information is consistent with the contents in the official website.

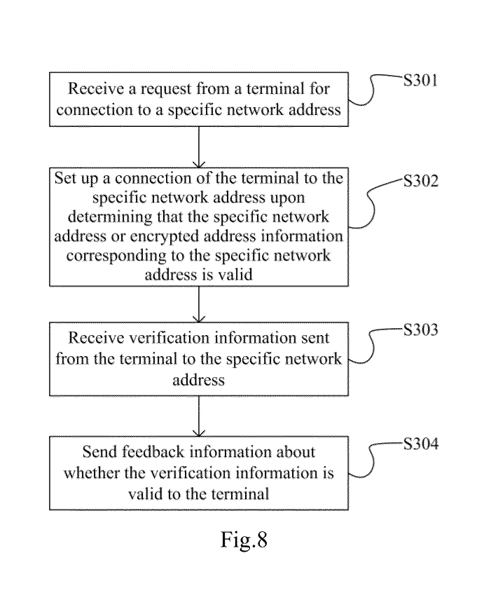

Referring to FIG. 8, a method for verifying anti-counterfeiting information according to an embodiment of the invention includes the following steps.

S301 is to receive a request from a terminal for connection to a specific network address.

S302 is to set up a connection of the terminal to the specific network address upon determining that the specific network address or encrypted address information corresponding to the specific network address is valid.

S303 is to receive verification information sent from the terminal to the specific network address.

S304 is to send feedback information about whether the verification information is valid to the terminal.

Preferably the received verification information shall be the same as or has a preset correspondence relationship with information stored in the specific network address. For example, a123456 is stored in the specific network address, and the terminal shall also send a123456; and in another example, after the terminal sets up a connection to the specific network address, a plurality of stored verification options are presented at the specific network address, and a user selects one of the options at the specific network address according to indicated contents of verification information carried by the object itself and sends the option as the verification information to the network address through the terminal.

Preferably the user is alerted to successful verification of the encrypted address information and instructed to enter corresponding verification information between S302 and S303.

Preferably when S302 is performed, the method further includes: determining the type of the encrypted address information; and determining that encrypted address information, corresponding to the encrypted address information, below the encrypted address information is invalidated upon determining that the encrypted address information is not the lowest encrypted address information. For example, first encrypted address information easy to obtain from the surface of the object is invalidated after second encrypted address information is obtained from the inside of the object and verified.

Preferably the method further includes: decrementing by one the remaining number of times that the encrypted address information, which is not the lowest, is to be verified; and determining that the encrypted address information, which is not the lowest, is invalidated upon determining that the remaining number of times that the encrypted address information is to be verified is zero. Thus higher encrypted address information can be avoided from being reused due to the absence of an invalidation mechanism, which would otherwise have incurred an anti-counterfeiting hole.

It will be difficult to reproduce the anti-counterfeiting approach due to multi-level verification and level-wise invalidation in the foregoing method.

Preferably the invalidated encrypted address information is stored into a recycle database. Thus the invalidated encrypted address information will be protected strictly from being recycled.

Preferably following S303, alike the method further includes: determining that verification information, corresponding to the verification information, below the verification information is invalidated upon determining that the verification information is not the lowest verification information. Preferably, the method further includes: decrementing by one the remaining number of times that the verification information, which is not the lowest, is to be verified; and determining that the verification information, which is not the lowest, is invalidated upon determining that the remaining number of times that the verification information is to be verified is zero. The method further includes: sending to the terminal an inquiry message about whether to determine the highest verification information and the highest encrypted address information of the object directly to be invalidated upon determining that the verification information is the highest verification information and the encrypted address information is the highest encrypted address information; and if there is a positive feedback from the terminal, then determining that the highest verification information and the highest encrypted address information are invalidated. For example, the terminal is inquired of about whether the object has been used upon determining that the second verification information and the second encrypted address information have been used, and if there is a positive feedback from the terminal, then it is indicated that the second verification information and the second encrypted address information of the object are of no more value to anti-counterfeiting and thus determined to be invalidated. Preferably in a general scenario, the inquiry mechanism will be triggered only if it is determined that the highest verification information and the highest encrypted address information (e.g., fourth verification information and third encrypted address information) are used when there are more than two pieces of verification information or encrypted address information. Preferably the invalidated verification information is stored into a recycle database.

In the foregoing respective solutions, determination by the server that the verification information is valid refers to determination by the server that the verification information is the same as or corresponding to information in the network address at which the verification information is received, where the verification information has not been invalidated. For example, the server has no entry record of the corresponding higher second verification information when the received verification information is the first verification information, and the number of times of being entered is below a preset number of times when the verification information is the second verification information.

Preferably when the verification information is valid, the corresponding feedback information includes one or more of the following parameters: the name of the object corresponding to the verification information, the type of the verification information, a historical record of verification times of the verification information, an invalidation alert corresponding to the verification information, the remaining number of times that the verification information is to be verified, the accumulated number of times that the verification information has been verified, a domain where the terminal sending the verification information resides, and the model of the terminal sending the verification information.

Preferably the feedback information that the verification information is valid is sent to a database of objects corresponding to the verification information when it is determined that the verification information is valid. With a synchronizing mechanism set up with the database of objects, the user can log onto a specified website and inquire of the database of objects to retrieve feedback information for check to thereby further guarantee the authenticity of the data.

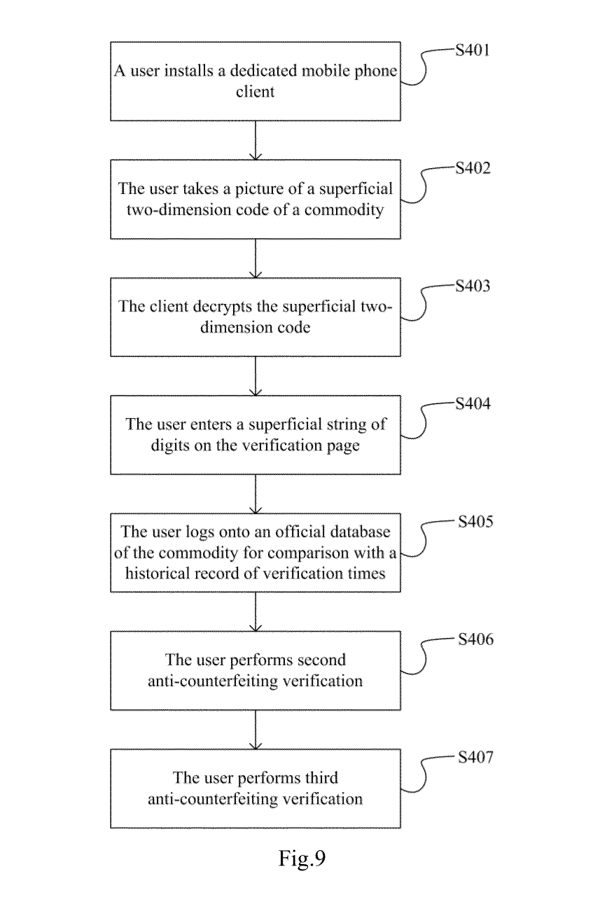

With the invention, an anti-counterfeiting verification function can be performed in client software or a customized terminal. In a particular embodiment, the terminal is a mobile phone with a photographing function, in which the client software according to the invention is installed, and the verification information in use is a string of digits, and the encrypted address information in use is a two-dimension code which can be implemented at a low cost, where it is determined that anti-counterfeiting verification is passed when the string of digits provided from the object is the same as the string of digits in the network address corresponding to the two-dimension code; and the first encrypted address information, the second encrypted address information, the first verification information and the second verification information according to the invention are more particularly referred to as a superficial two-dimension code, an underlying two-dimension code, a superficial verification string of digits and an underlying verification string of digits respectively in the particular embodiment dependent upon an application scenario. The steps S301 to S304 are performed at a network-side device which can be a cloud encryption server. Referring to FIG. 9, a particular embodiment of the invention will be given below.

S401. A user installs a dedicated mobile phone client which is application software installed on a mobile phone to take a picture of and identify a two-dimension code, where identified valid verification data (e.g., an address uniquely corresponding to the two-dimension code) is uploaded automatically to a cloud encryption server.

S402. The user takes a picture of a superficial two-dimension code of a commodity.

The superficial two-dimension code is affixed on the outside of the product and observable directly and capable of being photographing and identified by the dedicated mobile phone client, where each two-dimension code corresponds to a unique encrypted network address and records anti-counterfeiting verification information of the two-dimension code.

S403. The client decrypts the superficial two-dimension code.

If no network address is available from decryption, the commodity is a fake.

If the superficial two-dimension code is decrypted successfully but there is no entry to a correct verification page or it is indicated that the superficial two-dimension code has been invalidated, then it can be substantially determined that the commodity is a fake, where the verification page is for a mobile phone to enter a “Superficial/Underlying Verification String of Digits” for verification after accessing a unique network address corresponding to the two-dimension code over a network after the dedicated mobile phone client identifies the two-dimension code.

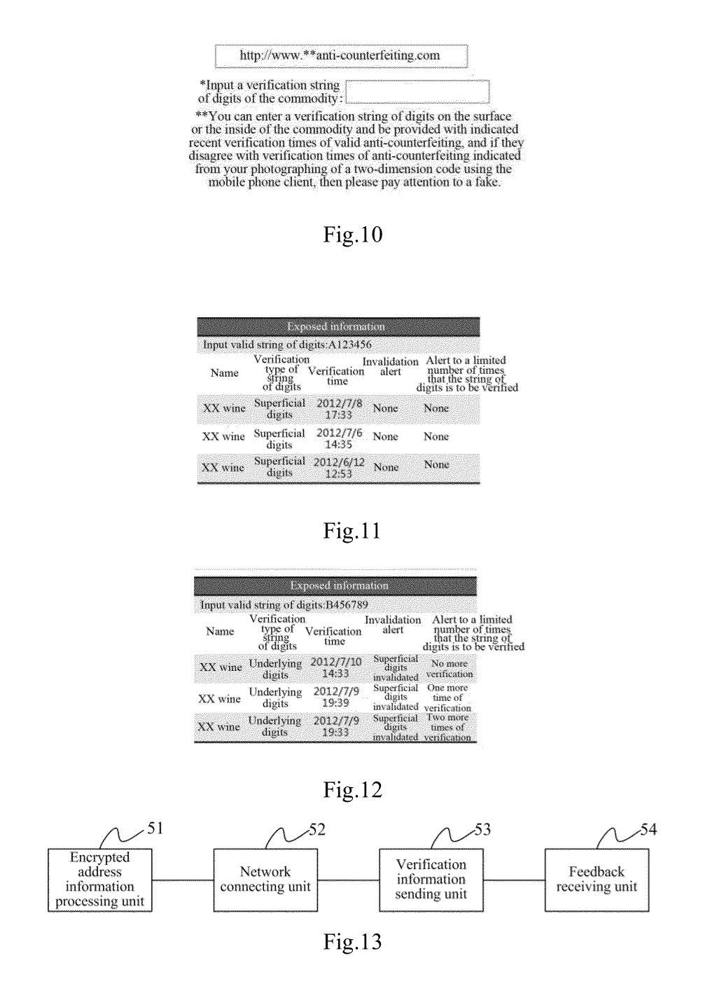

If the verification page is successfully connected to, then the flow proceeds to S404 as illustrated in FIG. 10.

S404. The user enters a superficial verification string of digits on the verification page.

The superficial verification string of digits is printed on the outside of the product (at the seal, etc.) to be entered for verification as instructed after the dedicated mobile phone client identifies the superficial/underlying two-dimension code.

If verification is not passed, then it can be determined that the commodity is a fake.

If verification is passed, then the verification time, source information about the commodity and other contents are displayed as illustrated in FIG. 11.

S405. The user logs onto an official database of the commodity for comparison with a historical record of verification times.

The user logs onto the official database of the commodity for comparison with the historical record of verification times available in the official database, and if there is a displayed match with the time indicated by the user, then it is determined that first anti-counterfeiting verification is valid, and the flow proceeds to S406.

S406. The user performs second anti-counterfeiting verification.

An underlying two-dimension code is obscured by a scratchable coating, a removable sheet of paper or otherwise and capable of being photographed by the mobile phone client.

The user is ready to purchase the commodity, removes/scratches an anti-counterfeiting label to expose the underlying two-dimension code, takes a picture of the underlying two-dimension code using the dedicated mobile phone client, and then enters the correct superficial verification string of digits, and the client indicates that it is valid but the superficial two-dimension code is invalidated and displays the verification time and the source information about the commodity corresponding to the underlying two-dimension code. The user accesses the official network and enters the superficial verification string of digits again for comparison, and then the historical record of several recent verification times is displayed, and it is indicated that the superficial two-dimension code is invalidated, and if there is a displayed match with the time indicated by the user, then it is determined that second anti-counterfeiting verification is valid.

S407. The user performs third anti-counterfeiting verification.

An underlying verification string of digits is located inside of the product (on the inside of a bottle cover, on the inside of a package, etc.) to be entered for verification as instructed after the dedicated mobile phone client identifies the superficial/underlying two-dimension code.

The user purchases the commodity and then opens the package and sees the underlying verification string of digits, and takes a picture of the underlying two-dimension code using the dedicated mobile phone client. The correct underlying verification string of digits is entered and indicated to be valid while the superficial verification string of digits is indicated to be invalidated, and the verification time and the source information of the commodity are displayed as illustrated in FIG. 12. The user accesses the official network and enters the underlying verification string of digits again for comparison, and then the historical record of several recent verification times is displayed, and it is indicated that both the superficial two-dimension code and the superficial verification string of digits are invalidated, and if there is a displayed match with the time indicated by the user, then it is determined that third anti-counterfeiting verification is valid.

Taking an alcohol commodity as an example, anti-counterfeiting information corresponding to the alcohol commodity in the foregoing verification steps is distributed as follows: a superficial two-dimension code affixed on a package box of the commodity, an underlying two-dimension code visible after the superficial two-dimension code is uncovered, a superficial verification string of digits on the outside of a bottle cover of the commodity, and an underlying verification string of digits visible on the inside of the removed bottle cover.

Referring to FIG. 13, an apparatus for verifying anti-counterfeiting information according to an embodiment of the invention includes:

an encrypted address information processing unit 51 configured to obtain and parse encrypted address information of an object;

a network connecting unit 52 configured to connect to a network address corresponding to the parsed encrypted address information;

a verification information sending unit 53 configured to determine that the encrypted address information is valid upon successful connection and send verification information of the object to the network address corresponding to the encrypted address information; and

a feedback receiving unit 54 configured to receive feedback information about whether the verification information is valid.

Preferably the encrypted address information includes first encrypted address information, and the verification information includes first verification information.

Preferably when the encrypted address information of the object further includes second encrypted address information, after the feedback receiving unit 54 receives the feedback information about whether the first verification information is valid, the encrypted address information processing unit 51 is further configured to obtain and parse the second encrypted address information of the object; the network connecting unit 52 is further configured to connect to a network address corresponding to the parsed second encrypted address information; the verification information sending unit 53 is further configured to determine that the second encrypted address information is valid upon successful connection and send the first verification information of the object to the network address corresponding to the second encrypted address information; and the feedback receiving unit 54 is further configured to receive again feedback information about whether the first verification information is valid.

Preferably when the verification information of the object further includes second verification information, after the feedback receiving unit 54 receives the feedback information about whether the first verification information is valid, the encrypted address information processing unit 51 is further configured to obtain and parse second encrypted address information of the object; the network connecting unit 52 is further configured to connect to a network address corresponding to the parsed second encrypted address information; the verification information sending unit 53 is further configured to determine that the second encrypted address information is valid upon successful connection and send the second verification information of the object to the network address corresponding to the second encrypted address information; and the feedback receiving unit 54 is further configured to receive feedback information about whether the second verification information is valid.

Preferably when the verification information of the object further includes second verification information, after the feedback receiving unit 54 receives the feedback information about whether the first verification information is valid, the encrypted address information processing unit 51 is further configured to obtain and parse again the first encrypted address information of the object; the network connecting unit 52 is further configured to connect again to the network address corresponding to the parsed first encrypted address information; the verification information sending unit 53 is further configured to determine again that the first encrypted address information is valid upon successful connection and send the second verification information of the object to the network address corresponding to the first encrypted address information; and the feedback receiving unit 54 is further configured to receive feedback information about whether the second verification information is valid.

Preferably when the verification information is valid, the corresponding feedback information includes one or more of the following information: the name of the object corresponding to the verification information, the type of the verification information, a historical record of verification times of the verification information, an invalidation alert corresponding to the verification information, the remaining number of times that the verification information is to be verified, the accumulated number of times that the verification information has been verified, a domain where a terminal sending the verification information resides, and the model of the terminal sending the verification information.

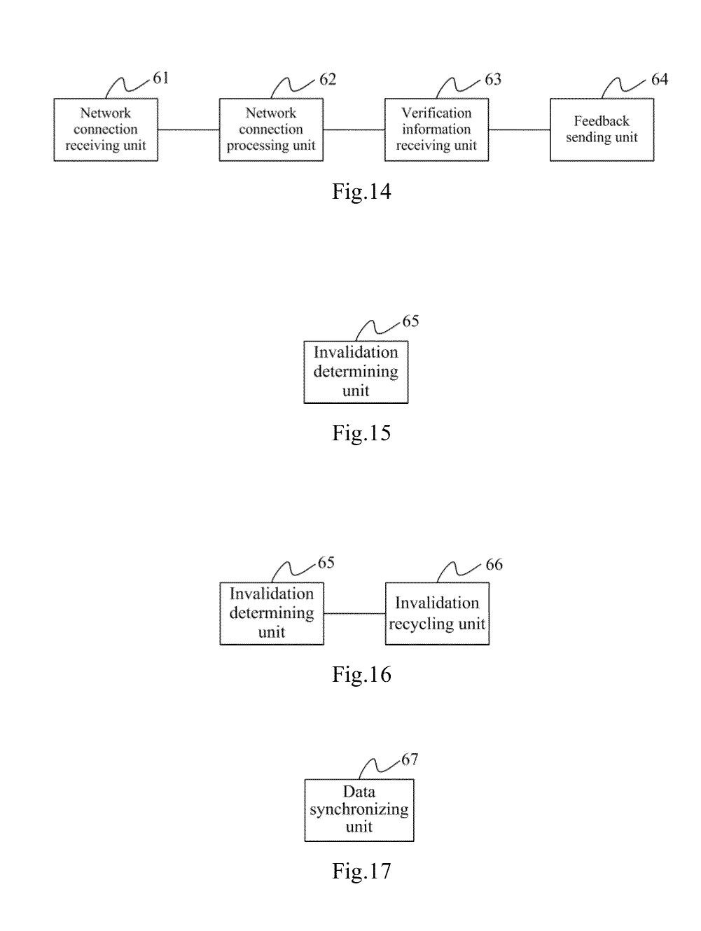

Referring to FIG. 14, an apparatus for verifying anti-counterfeiting information according to an embodiment of the invention includes:

a network connection receiving unit 61 configured to receive a request from a terminal for connection to a specific network address;

a network connection processing unit 62 configured to set up a connection of the terminal to the specific network address upon determining that the specific network address or encrypted address information corresponding to the specific network address is valid;

a verification information receiving unit 63 configured to receive verification information sent from the terminal to the specific network address; and

a feedback sending unit 64 configured to send feedback information about whether the verification information is valid to the terminal.

Preferably, referring to FIG. 15, the apparatus further includes:

an invalidation determining unit 65 configured to determine the type of the encrypted address information corresponding to the specific network address upon determining that the specific network address or the encrypted address information is valid; and

to determine that encrypted address information, corresponding to the encrypted address information, below the encrypted address information is invalidated upon determining that the encrypted address information is not the lowest encrypted address information.

Preferably the invalidation determining unit 65 is further configured:

to decrement by one the remaining number of times that the encrypted address information, which is not the lowest, is to be verified; and

to determine that the encrypted address information, which is not the lowest, is invalidated upon determining that the remaining number of times that the encrypted address information is to be verified is zero.

Preferably, referring to FIG. 16, the apparatus further includes:

an invalidation recycling unit 66 configured to store the invalidated encrypted address information into a recycle database.

Preferably the invalidation determining unit 65 is further configured to determine that verification information, corresponding to the verification information, below the verification information is invalidated upon determining that the verification information is not the lowest verification information.

Preferably the invalidation determining unit 65 is further configured:

to decrement by one the remaining number of times that the verification information, which is not the lowest, is to be verified; and

to determine that the verification information, which is not the lowest, is invalidated upon determining that the remaining number of times that the verification information is to be verified is zero.

Preferably the invalidation determining unit 65 is further configured:

to send to the terminal an inquiry message about whether to determine the highest verification information and the highest encrypted address information of the object directly to be invalidated upon determining that the verification information is the highest verification information and the encrypted address information is the highest encrypted address information; and

if there is a positive feedback from the terminal, to determine that the highest verification information and the highest encrypted address information are invalidated.

Preferably the invalidation recycling unit 66 is further configured to store the invalidated verification information into the recycle database.

Preferably when the verification information is valid, the corresponding feedback information includes one or more of the following information:

the name of the object corresponding to the verification information, the type of the verification information, a historical record of verification times of the verification information, an invalidation alert corresponding to the verification information, the remaining number of times that the verification information is to be verified, the accumulated number of times that the verification information has been verified, a domain where the terminal sending the verification information resides, and the model of the terminal sending the verification information.

Preferably, referring to FIG. 17, the apparatus further includes:

a data synchronizing unit 67 configured to send the feedback information that the verification information is valid to a database of objects corresponding to the verification information when it is determined that the verification information is valid.

In summary, the embodiments of the invention provide a method and apparatus for verifying anti-counterfeiting information so as to improve an anti-counterfeiting effect, to lower an anti-counterfeiting cost, to extend the scope of population to which anti-counterfeiting effect is applicable and to guarantee the stability of anti-counterfeiting means.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable data processing device provide steps for performing the functions specified in the flow(s) of the flow chart and/or the block(s) of the block diagram.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for verifying anti-counterfeiting information, comprising:
obtaining and parsing, by a terminal, encrypted address information of an object;
connecting, by the terminal, to a network address corresponding to the parsed encrypted address information;
determining, by the terminal, that the encrypted address information is valid upon successful connection and sending verification information of the object to the network address corresponding to the encrypted address information; and
receiving, by the terminal, feedback information about whether the verification information is valid.

2. The method according to claim 1, wherein the encrypted address information includes first encrypted address information, and the verification information includes first verification information.

3. The method according to claim 2, wherein when the encrypted address information of the object further includes second encrypted address information, after the feedback information about whether the first verification information is valid is received, the method further comprises:
obtaining and parsing, by the terminal, the second encrypted address information of the object;
connecting, by the terminal, to a network address corresponding to the parsed second encrypted address information;
determining, by the terminal, that the second encrypted address information is valid upon successful connection and sending the first verification information of the object to the network address corresponding to the second encrypted address information; and
receiving, by the terminal, again feedback information about whether the first verification information is valid.

4. The method according to claim 2, wherein when the verification information of the object further includes second verification information, after the feedback information about whether the first verification information is valid is received, the method further comprises:
obtaining and parsing, by the terminal, second encrypted address information of the object;
connecting, by the terminal, to a network address corresponding to the parsed second encrypted address information;
determining, by the terminal, that the second encrypted address information is valid upon successful connection and sending the second verification information of the object to the network address corresponding to the second encrypted address information; and
receiving, by the terminal, feedback information about whether the second verification information is valid.

5. The method according to claim 2, wherein when the verification information of the object further includes second verification information, after the feedback information about whether the first verification information is valid is received, the method further comprises:
obtaining and parsing, by the terminal, again the first encrypted address information of the object;
connecting, by the terminal, again to the network address corresponding to the parsed first encrypted address information;
determining, by the terminal, again that the first encrypted address information is valid upon successful connection and sending the second verification information of the object to the network address corresponding to the first encrypted address information; and
receiving, by the terminal, feedback information about whether the second verification information is valid.

6. A method for verifying anti-counterfeiting information, comprising:
receiving a request from a terminal for connection to a specific network address;
setting up a connection of the terminal to the specific network address upon determining that encrypted address information corresponding to the specific network address is valid;
receiving verification information sent from the terminal to the specific network address; and
sending feedback information about whether the verification information is valid to the terminal.

7. The method according to claim 6, wherein when it is determined that the encrypted address information corresponding to the specific network address is valid, the method further comprises:
determining the type of the encrypted address information; and
determining that encrypted address information, corresponding to the encrypted address information, below the encrypted address information is invalidated upon determining that the encrypted address information is not the lowest encrypted address information.

8. The method according to claim 7, further comprising:
decrementing by one the remaining number of times that the encrypted address information, which is not the lowest, is to be verified; and
determining that the encrypted address information, which is not the lowest, is invalidated upon determining that the remaining number of times that the encrypted address information is to be verified is zero.

9. The method according to claim 7, further comprising:
storing the invalidated encrypted address information into a recycle database.

10. The method according to claim 6, wherein after the verification information sent from the terminal to the specific network address is received, the method further comprises:
determining that verification information, corresponding to the verification information, below the verification information is invalidated upon determining that the verification information is not the lowest verification information.

11. The method according to claim 10, further comprising:
decrementing by one the remaining number of times that the verification information, which is not the lowest, is to be verified; and
determining that the verification information, which is not the lowest, is invalidated upon determining that the remaining number of times that the verification information is to be verified is zero.

12. The method according to claim 6, further comprising:
sending to the terminal an inquiry message about whether to determine the highest verification information and the highest encrypted address information of the object directly to be invalidated upon determining that the verification information is the highest verification information and the encrypted address information is the highest encrypted address information; and
if there is a positive feedback from the terminal, then determining that the highest verification information and the highest encrypted address information are invalidated.

13. The method according to claim 10, further comprising:
storing the invalidated verification information into the recycle database.

14. The method according to claim 6, wherein when the verification information is valid, the corresponding feedback information includes one or more of the following information:
the name of the object corresponding to the verification information, the type of the verification information, a historical record of verification times of the verification information, an invalidation alert corresponding to the verification information, the remaining number of times that the verification information is to be verified, the accumulated number of times that the verification information has been verified, a domain where the terminal sending the verification information resides, and the model of the terminal sending the verification information.

15. The method according to claim 14, further comprising:
sending the feedback information that the verification information is valid to a database of objects corresponding to the verification information upon determining that the verification information is valid.

16. An apparatus for verifying anti-counterfeiting information, comprising:
an encrypted address information processing unit configured to obtain and parse encrypted address information of an object;
a network connecting unit configured to connect to a network address corresponding to the parsed encrypted address information;
a verification information sending unit configured to determine that the encrypted address information is valid upon successful connection and send verification information of the object to the network address corresponding to the encrypted address information; and
a feedback receiving unit configured to receive feedback information about whether the verification information is valid.

17. The apparatus according to claim 16, wherein the encrypted address information includes first encrypted address information, and the verification information includes first verification information.

18. The apparatus according to claim 17, wherein when the encrypted address information of the object further includes second encrypted address information, after the feedback receiving unit receives the feedback information about whether the first verification information is valid,
the encrypted address information processing unit is further configured to obtain and parse the second encrypted address information of the object;
the network connecting unit is further configured to connect to a network address corresponding to the parsed second encrypted address information;
the verification information sending unit is further configured to determine that the second encrypted address information is valid upon successful connection and send the first verification information of the object to the network address corresponding to the second encrypted address information; and
the feedback receiving unit is further configured to receive again feedback information about whether the first verification information is valid.

19. The apparatus according to claim 17, wherein when the verification information of the object further includes second verification information, after the feedback receiving unit receives the feedback information about whether the first verification information is valid,
the encrypted address information processing unit is further configured to obtain and parse second encrypted address information of the object;
the network connecting unit is further configured to connect to a network address corresponding to the parsed second encrypted address information;
the verification information sending unit is further configured to determine that the second encrypted address information is valid upon successful connection and send the second verification information of the object to the network address corresponding to the second encrypted address information; and
the feedback receiving unit is further configured to receive feedback information about whether the second verification information is valid.

20. The apparatus according to claim 17, wherein when the verification information of the object further includes second verification information, after the feedback receiving unit receives the feedback information about whether the first verification information is valid,
the encrypted address information processing unit is further configured to obtain and parse again the first encrypted address information of the object;
the network connecting unit is further configured to connect again to the network address corresponding to the parsed first encrypted address information;
the verification information sending unit is further configured to determine again that the first encrypted address information is valid upon successful connection and send the second verification information of the object to the network address corresponding to the first encrypted address information; and
the feedback receiving unit is further configured to receive feedback information about whether the second verification information is valid.
